(19) United States
(12) Patent Application Publication
(10) Pub. No.: US 2019/0180297 A1
(43) Pub. Date: Jun. 13, 2019

(54) Live Event Ticket Pricing Engine and Services

(71) Applicant: Amazon Technologies, Inc., Seattle, WA (US)

(72) Inventors: Upneet Bhatia, Seattle, WA (US); Leigh J. Castergine, Jersey City, NJ (US); Joseph Hopkins, Seattle, WA (US); David Daniel Glick, Seattle, WA (US)

(73) Assignee: Amazon Technologies, Inc.

(21) Appl. No.: 15/834,790

(22) Filed: Dec. 7, 2017

(51) Int. Cl. G06Q 30/02; G06F 17/30

(52) U.S. Cl. CPC G06Q 30/0202; G06Q 30/0206; G06Q 30/0205; G06F 17/30867

(57) ABSTRACT

Methods and systems for determining optimal ticket pricing using an estimated future interest in a live event. The methods and systems may include processors configured to determine relationships that are indicative of interest in a live event using one or more types of data, including live event data that indicates characteristics of individual live events, ticket data that indicates information regarding ticket sales to past live events, user data that indicates characteristics, past purchases, and/or affinities of individual users. The processors may also generate and maintain a live event interest model that is configured to use one or more determined relationships to estimate interest in an upcoming live event. The processors may use one or more types of data, the determined relationships, or the live event interest model to estimate future interest in an upcoming live event.

### BACKGROUND

The marketplace for tickets to live events is worth billions of dollars annually, with the concert ticketing industry being worth more than $7 billion dollars each year and the ticket marketplace for live sporting event also representing billions of dollars of revenue. However, due to the difficulty of predicting future interest in a live event, live event venues and ticket providers err on the side of lower list values (e.g. lower ticket prices) for tickets to ensure that a threshold quantity of tickets are purchased. This means that a large portion of the monetary value of the ticket marketplace is captured by resellers on the secondary market, and not the venues or artists/athletes that are providing the live performance. That is, because ticket sellers are unable to accurately predict future demand for their live events, tickets live events that are exceptionally popular may be purchased and resold for values far above their original list value. Additionally, because of the difficulty in predicting future interest in live events, providers of live events often struggle to identify the venues, cities, and/or pricing schedules that are in their best interests.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different figures indicates similar or identical components or features.

FIG. 1 is a block diagram illustrating an example of a system for determining optimal ticket pricing using an estimated future interest in a live event.

FIG. 2 is a block diagram of an illustrative computing architecture of the system for estimating interest in upcoming live events shown in FIG. 1.

FIG. 3 is a flow diagram of an illustrative process to determine ticket prices for an upcoming live event based on estimated interest in the upcoming live event.

FIG. 4 is a flow diagram of an illustrative process to determine one or more relationships indicative of interest in a live event.

FIG. 5 is an example illustration of a live event interest estimation service.

FIG. 6 is an example illustration of a service for managing and scheduling live events using a live event interest service.

FIG. 7 is an example illustration of a service for browsing and obtaining tickets to live events using a live event interest service.

### DETAILED DESCRIPTION

Embodiments of the present disclosure are directed to methods and systems for determining optimal ticket pricing using an estimated future interest in a live event. The described methods and systems address the technical problem of ticket resale on internet secondary markets. Currently, scalpers are able to purchase tickets from an online ticket service and then immediately post them on a competing ticket website higher prices, driving up ticket prices for live events to the highest value the ticket market will bear. This means that, because current ticket retail resources are (i) unable to predict what the ticket market will bear, or (ii) cannot adjust their prices based on secondary markets, value that should rightly go to the venues and acts that provide live events is instead currently captured by scalpers. The described systems and methods address this problem by presenting functionality to better estimate ticket value that the market will bear, while also being able to adjust ticket prices based on current factors (such as prices on secondary markets, velocity of ticket sales, social trending, etc.).

A live event may be a play, dance, opera, music concert, talk, conference/convention, sporting event, or other performance to which individuals can attend and/or experience in person. Tickets may correspond to passes that grant an individual a right to attend a live event and/or rights to a particular seat or location at a live event. An act may be an individual or collection of individuals that perform at a live event, such as an athlete, a speaker, a team, an emcee, an actor/actress, a musician, band, or other performer(s).

In some embodiments, the methods and systems may include processors configured to predict a level of interest in a future event. The processors may also be configured to determine optimal pricing for tickets for the future event based on the predicted level of interest. The processors may also calculate levels of interest in one or more different types of tickets to a live event (e.g., general admission, reserved seating, VIP seating, balcony, orchestra, floor, etc.), and may determine pricing for individual types of seating based on corresponding levels of interest. The processors may also be configured to periodically re-determine interest and price of tickets to an event, predict future changes in interest in live event, and/or estimate a time at which the live event will sell out.

In some embodiments, the processors may determine relationships that are indicative of interest in a live event. The relationships may be determined based on one or more types of data, including: live event data that indicates characteristics of individual live events, ticket data that indicates information regarding ticket sales to past live events, user data that indicates characteristics, past purchases, and/or affinities of individual users, etc. The processors may also generate and maintain a live event interest model that is configured to use one or more determined relationships to estimate interest in an upcoming live event. The live event interest model may use computer learning to optimize its ability to predict interest in live events. The model may also be maintained by identifying new relationships and/or modifying previously determined relationships based on new data.

The processors may use one or more types of data, the determined relationships, or the live event interest model to estimate future interest in an upcoming live event. In some embodiments, the processors may then predict levels of future interest in tickets to live event for different ticket price points. For example, the processors may determine a first estimated interest for $25 tickets to a live event, and a second estimated interest for $20 tickets to the same live event. In this way, the processors can predict what ticket prices would result in the highest number of ticket sales, the greatest gross profit, etc.

The processors may also use the estimated future interest in a live event to predict an optimal price for tickets of the live event, a velocity of tickets sales at different price points, an estimated probability/date that the live event will sell out, total sales of tickets to the live event, what users or groups of users are likely to be interested in purchasing tickets to the live event, etc. The processors may also be able to determine whether a particular ticket price is proportional to the expected level of interest in the live event. In this way, the processors may determine if tickets are being priced at a reasonable cost.

In some embodiments, the processors may provide services that may be used by venues to determine what prices to sell tickets to an upcoming live event for, and/or what type of tickets to sell (e.g., VIP, general admission, seated admission, etc.). The services provided by the processors may also enable venues to select acts/events to book at their location(s)/venue(s). For example, the processors may use one or more types of data, the determined relationships, or the live event interest model to estimate interest in various acts/live events, and may select the acts/live events for which the processors predict the highest level of interest. Also, because the processors may also allow venues to predict an amount of tickets that would be sold at a particular ticket price, the processors may enable venues to estimate an amount of profit that it would likely make on a live event.

In some embodiments, the processors may provide services that may be used by acts and/or their representatives to determine venues at which to book live events, which cities to include in their live event tours, what acts to include in individual live events, how much to charge for tickets, etc. For example, the processors may use one or more types of data, the determined relationships, or the live event interest model to estimate interest in a live show in a city, and may recommend venues that the act can sell out and/or maximize their profits for the live event. In some embodiments, the processors may take into account the goals of a live event. For example, where an act wishes to maximize its profits, the processors may recommend a smaller venue with higher priced tickets, whereas if the act wishes to maximize exposure the processors may recommend a larger venue and lower prices for tickets.

In some embodiments, the processors may provide services that may be used by users to view and obtain tickets to live events. The services provided by the processors may also enable users to purchase tickets for a live event, to determine whether tickets for a live event are reasonably priced (i.e., tickets on secondary markets), to predict future changes in ticket prices (e.g., sold by the processors or on secondary markets), and so on.

In some embodiments, the processors may maintain a database of available tickets and encumbered tickets and provide one or more graphical user interfaces that allow users to browse available tickets (e.g., via an interactive seat map associated with a venue of the live event), and purchase tickets to the live event. For example, the graphical user interface(s) may indicate available tickets on a seat map of the venue and include functionality for selecting and purchasing individual tickets. In some embodiments, the processors may use one or more types of data, the determined relationships, or the live event interest model to dynamically price tickets for a live event such that they are reasonably priced in relation to estimated interest in the live event. For example, where tickets are being purchased at a high velocity, the processors may adjust the price based on an estimated increase in interest for the event.

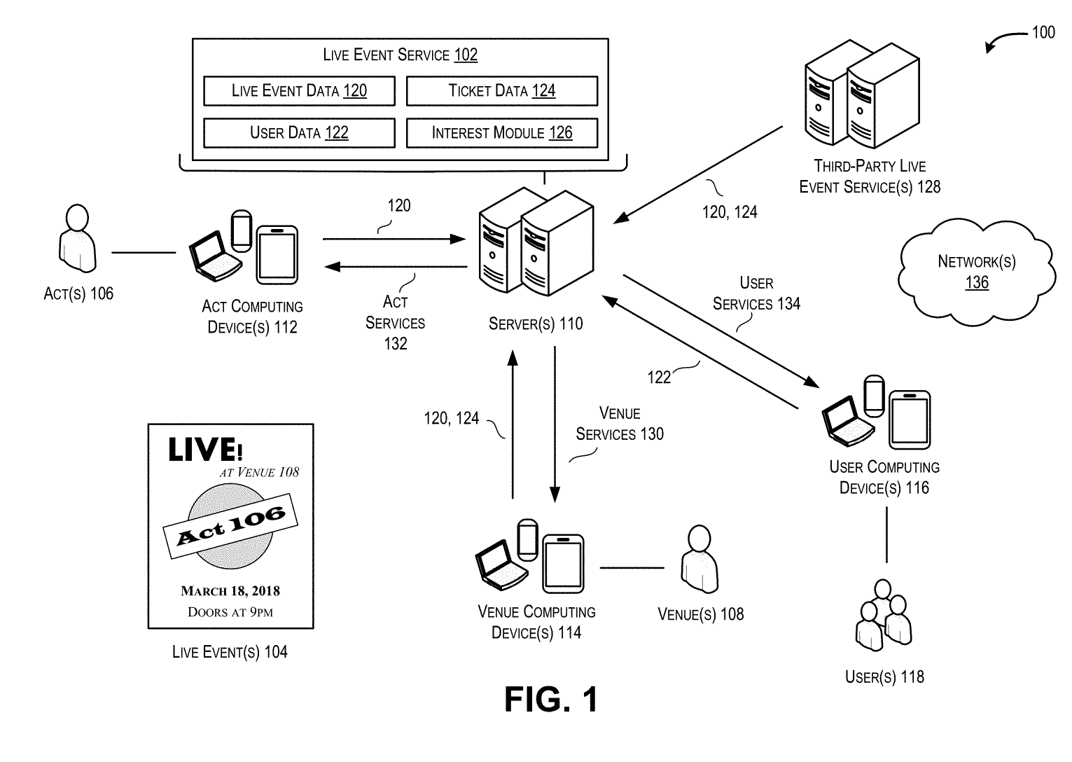

FIG. 1 is a diagram illustrating an example environment 100 of a system for determining optimal ticket pricing using an estimated future interest in a live event. The environment 100 includes a live event service 102 that is configured to determine relationships indicative of interest in a live event and/or predict an estimated level of interest in an upcoming live event 104. A live event 104 may be a theater, dance, opera, music concert, talk, sporting event, or other performance by an act 106 that occurs at a venue 108, and to which individuals can attend and/or experience in person. An act 106 may be an individual or collection of individuals that perform at a live event 104, such as an athlete, a speaker, a team, an emcee, an actor/actress, a musician, band, or other performer(s). Alternatively, or in addition, the act 106 may include a third party that represents and/or performs services on an act's 106 behalf, such as a promoter, an agent, manger, etc. A venue 108 may include a location and/or structure (e.g., park, stadium, field, arena, theater, stage, field, amphitheater, etc.) at which a live event occurs. A venue 108 may include a third party that represents and/or performs services on a venue's 108 behalf, such as a promoter, an agent, manger, etc.

The live event service 102 may be run (i.e., stored, hosted, executed, etc.) on a computing entity, such as a smartphone, smart camera, tablet, personal computer, laptop, voice controlled computing device, server system, or other computing system that is able to execute and/or present one or more functionalities associated with the live event service 102. FIG. 1 depicts live event service 102 as being hosted by servers 110, which may be any entity, server(s), platform, etc. In some embodiments, the live event service 102 may be associated with or incorporated into an another service that utilizes estimated interest in upcoming live events, such as an ecommerce ticket pricing service (e.g., a website, electronic application, widget, etc.) that prices tickets and/or other goods and service associated with a live event based on expected interest, an act promoting service that schedules and/or promotes live events in relation to expected, a venue operations service that books acts and/or determines expected operations overheads (e.g., expected sales, required staffing, etc.) based on expected interest, etc.

FIG. 1 also depicts one or more act computing devices 112 associated with acts 106, one or more venue computing devices 114 associated with venues 108, and one or more user computing devices 116 associated with users 118. Any of these computing devices 112, 114, and 116 may be any type of computing device, such as a smartphone, smart camera, tablet, personal computer, laptop, voice controlled computing device, or other device.

FIG. 1 also shows the live event service 102 as including live event data 120, user data 122, ticket data 124, and an interest module 126. The live event data 120 may be data that identify characteristics associated with the live event 104, such as a type of event (e.g., concert, sporting event, speaker, etc.), acts 106 involved in the live event 104, a genre of the act 106 (e.g., metal, theatre, soccer, etc.), subgenre (e.g., speed metal, women's college soccer, a ballet or play, etc.), characteristics of the venue 104 (e.g., size, seating capacity, past ticket sales for live events at the venue, average attendance, seating types, etc.), date, time, characteristics of the acts 106 (e.g., ticket information for past performances, album sales, album release dates, social media information, etc.), similar events by the act(s) 106 (e.g., multiple shows at the venue, other tour dates, periodic performances, etc.), regional popularity, other modifiers that might affect the level of interest in the live event 104 (e.g., this is the act's final tour, the live event 104 is the last show of a tour, the live event 104 is an album release party, special guests/performers, hometown performance, a promotion being run at the live event 104, etc.), and/or other information that indicates information about a live event 104. The live event service 102 may acquire the live event data 120 from one or more different sources, such as from act computing device 106 and venue computing devices 114. For example, the live event service 102 may receive information about a venue 108 from an application executing on an associated venue computing device 114. In some embodiments, the live event service 102 may receive live event data 120 from one or more third-party live event services 128, such as ticket selling services, live event promotion services, etc.

The user data 122 may include data that indicates information/affinities of potential ticket purchasers (i.e., users 118), such as a user's favorite acts, favorite genres, liked albums, types of live events they have previously purchased tickets to, affinity for going to live events, type of seating preferred, type of venue preferred, pricing thresholds for one or more types of seating (e.g., majority of tickets purchased by user are under $30), demographic information about the user (e.g., age, gender, income, etc.), geographic information of the user (e.g., where they work, live, travel, etc.), other users that they go to live events with, etc. The user data 122 may be collected by the live event service 102 or one or more other associated services (e.g., an ecommerce platform, a social media service, etc.) via interactions with user computing devices 116 associated with individual users 118.

The ticket data 124 may correspond to data that indicates information relating to previous live events, such as information relating to ticket sales for one or more past live events (e.g., number of tickets sold, velocity of ticket sales, price of tickets, types of tickets offered, price of tickets on secondary markets, time until the live event sold out, users that attended the live event, etc.). The ticket data 124 may be generated by the live event service 102, or may be received from one or more other sources, such as ticket selling services, one or more venue computing devices 114, a third-party live event service 128, etc.

The interest module 126 can be executable by one or more processing units of the live event service 102 to use one or more types of data (e.g., the live event data 120, the user data 122, the ticket data 124, etc.) to predict future interest in a live event 104. As used herein, the term “module” is intended to represent example divisions of executable instructions for purposes of discussion, and is not intended to represent any type of requirement or required method, manner or organization. Accordingly, while various “modules” are described, their functionality and/or similar functionality could be arranged differently (e.g., combined into a fewer number of modules, broken into a larger number of modules, etc.). Further, while certain functions and modules are described herein as being implemented by software and/or firmware executable on a processor, in other instances, any or all of the modules can be implemented in whole or in part by hardware (e.g., a specialized processing unit, etc.) to execute the described functions. In various implementations, the modules described herein in association with live event service 102 can be executed across multiple devices.

In some embodiments, the interest module 126 can use the one or more types of data to determine relationships that are indicative of interest in tickets to a live event 104. The relationships may correspond to combinations of one or more characteristics (i.e., characteristics of users 118, characteristics of a venue 108, characteristics of an act 106, characteristics of a live event 104, etc.) that correlate to either an increase or decrease in likelihood that a user 118 will purchase a ticket to a live event 104. That is, the interest module 126 may be configured to use one or more combinations of user information and live event information that are predictive of an affinity for purchasing a ticket. For example, the interest module 126 may determine a first relationship that indicates that users that live in urban areas and that have previously purchased cowboy boots have a higher likelihood of wanting to attend a live event that involves a country music act, and a second relationship that indicates that users that have purchased a Los Angeles Lakers jersey are likely to purchase tickets to a live event that involves the Dallas Cowboys.

The live event service 102 may use a combination of one or more of data (e.g., the live event data 120, the user data 122, the ticket data 124, etc.), new data indicating characteristics of an upcoming live event 104, and the determined relationships to estimate future interest in the upcoming live event 104. For example, the live event service 102 may estimate a high level of interest in an upcoming live event 104 where the act Trampled by Turtles is playing at the Wonder Ballroom because a relationship determined by the interest module 126 indicates that bluegrass fans of ages of 18-29 purchase tickets to Trampled by Turtles events at a high rate, and that user data 122 indicates that there are a lot of bluegrass fans between the ages of 18-29 in the Portland metropolitan area.

In some embodiments, the live event service 102 may use the relationships to generate a model that is able to estimate future interest in upcoming live events 104. The live event service 102 may also use computer learning to optimize such a model to improve its ability to predict interest in upcoming live events 104. The live event service 102 may also may also maintain the model by identifying new relationships and/or modifying previously determined relationships based on new data and/or new relationships identified by the interest module 126.

In some embodiments, the live event service 102 and/or the interest model 126 may assign weights or other values to individual relationships based on the strength of the correlation between the combination of one or more characteristics and purchasing tickets to a live event. The weights and or values may be determined such that they are indicative of a relative increase or decrease in interest in a live event having set traits. For example, if the live event service 102 and/or the interest model 126 has determined that women ages 18-24 who have purchased green hair dye have purchased tickets to live events featuring the band The Regrettes, the live event service 102 and/or the interest model 126 may assign a large weight to this relationship.

In some embodiments, the live event service 102 may use the interest model 126 to determine how changing one or more characteristics of an upcoming live event 104 (e.g., dates, times, different ticket prices, different acts, general admission vs. seated tickets, etc.) would be expected to affect interest in the live event 104. For example, the live event service 102 may determine a first estimated interest for general admission tickets to a live event 104, and a second estimated interest for seated tickets to the same live event 104. To identify the estimated interest, the live event service and/or the interest model 126 may identify a set of users 118 that are located within a threshold distance of a venue 108 at which a live event 114 is to occur, identify characteristics of the set of users 118, the venue 108, the acts 106 performing at the live event 104, the live event 104, etc. and then use the weights and/or other values to determine a likelihood that individual users 118 of the set of users 118 would purchase tickets to the live event 104.

In this way, the live event service 102 can determine optimal characteristics for an upcoming live event 104 that most closely aligns with user interest. For example, the live event service 102 may determine that the highest ticket price for an upcoming live event 104 that is still likely to cause the live event 104 to sell out is $55. In this way, instead of pricing tickets below this value and having scalpers and resellers capture the surplus value (i.e., $55 minus the price of the tickets) on the secondary market, acts 106 and venues 108 are able to capture the full value of the services that they provide. The live event service 102 may also use estimated level of interest in an upcoming event to estimate other values such as an expected velocity of tickets sales at different price points, an estimated probability/date that the live event 104 will sell out, total sales of tickets to the live event 104, what users or groups of users are likely to be interested in purchasing tickets to the live event 104, etc.

In some embodiments, the live event service 102 may provide venue services 130 to the venue computing devices 114 that may be used by the venues 108. The venue services 130 may correspond to a website, portal, application, widget, etc. that is configured to provide functionalities for managing and/or determine optimal characteristics for an upcoming live event 104. The venue service may include an interface that indicates suggested prices to sell tickets to an upcoming live event 104, and/or an identification of which type of tickets to sell (e.g., VIP, general admission, seated admission, etc.). For example, the venue service may include an interface that uses the estimated levels of interest to determine an optimum ratio of premium tickets (e.g., VIP tickets) to general admission tickets so as to meet expected demand, to maximize ticket sales, to maximize profits, or a combination thereof.

In some embodiments, the venue services 130 may also enable venues 108 to select acts/events to book at their location (i.e., what acts/events are estimated to generate highest level of interest). For example, the venue services 130 may include an interface that provides functionalities for modifying/adjusting characteristics of an upcoming live event 104, and then may determine an estimated interest in a live event 104 having the modified/adjusted characteristics. The venue services 130 may also present one or more suggestions of live events 104 and/or characteristics of live events 104 that would likely generate an estimated high/increase in interest. For example, the venue services 130 may recommend that a venue 108 book an act 106 that is popular in its area, and who is scheduled to have a night off after playing another live event 104 in a nearby city. The venue services 130 may also provide functionalities for contacting acts 106 or otherwise arranging live events 104.

In some embodiments, the live event service 102 may provide act services 132 to acts computing device(s) 112 that may be used by acts 106 and/or their representatives. For example, the act services 132 may correspond to a website, portal, application, widget, etc. that is configured to provide functionalities for determining venues 108 at which to book live events 104, which cities to include in their live event 104 tours, what other acts to include in individual live events 104, a suggested price for tickets, etc. For example, the live event service 102 may use one or more of the types of data 120, 122, 124 and the determined relationships and/or the live event 104 interest model to estimate interest in a live event 104 in a particular city, and then recommend venues 108 within that city that the live event service 102 estimates the act 106 can sell out and/or maximize their profits for the live event 104. The act services 132 may take into account the goals of an act when recommending venues, prices, other acts etc. for an upcoming live event 104. For example, if the act 106 wishes to maximize its profits, the live event service 102 may recommend a smaller venue with higher priced tickets, whereas if the act wishes to maximize exposure, the live event service 102 may recommend joining an upcoming live event 104 that already features another popular act.

In some embodiments, the act services 132 may also include functionalities for managing upcoming live events 104. Such functionalities may include indications of how many tickets have been sold to upcoming shows, ticket sales velocity for upcoming shows, whether/when upcoming shows are expected to sell out, options for increasing advertising for upcoming shows, etc. The act services 132 may also include recommendations of live events 104 that the act should book, other acts that need an extra gig, upcoming live events 104 that need an extra act, etc.

The live event service 102 may provide user services 134 to user computing devices 116 associated with individual users 118. For example, the act services 132 may correspond to a website, portal, application, widget, etc. that is configured to provide functionalities for viewing and obtaining tickets to live events 104. The act services 132 may also enable users 118 to purchase tickets for a live event 104, to determine tickets for a live event 104 are reasonably priced (i.e., tickets on secondary markets), to predict future changes in ticket prices (e.g., sold by the processors or on secondary markets), etc.

In some embodiments, where the live event service 102 maintains a database of available tickets and encumbered tickets, the act services 132 may include one or more graphical user interfaces that allow users 118 to browse available tickets (e.g., via an interactive seat map associated with a venue of the live event 104), and purchase tickets to the live event 104. For example, the graphical user interfaces may indicate available tickets on a seat map of the venue and include functionality for selecting and purchasing individual tickets. In some embodiments, the live event service 102 may use one or more types of data, the determined relationships, or the live event 104 interest model to dynamically price tickets for a live event 104, so that the act services 132 sell tickets at prices that reflect the estimated interest in the live event 104. In some embodiments, the live event service 102 may determine the price for tickets may also be determine based at least in part on an identify of a user. For example, the price of a ticket may be reduced for each friend of the user that purchases a ticket to the live event 104, or may be reduced if a user is a member, subscriber, preferred customer, etc., of the live event service 102. FIG. 1 further illustrates each of the servers 110, the act computing devices 112, the venue computing devices 114, and the user computing devices 116 as being connected to a network 136, such as the internet.

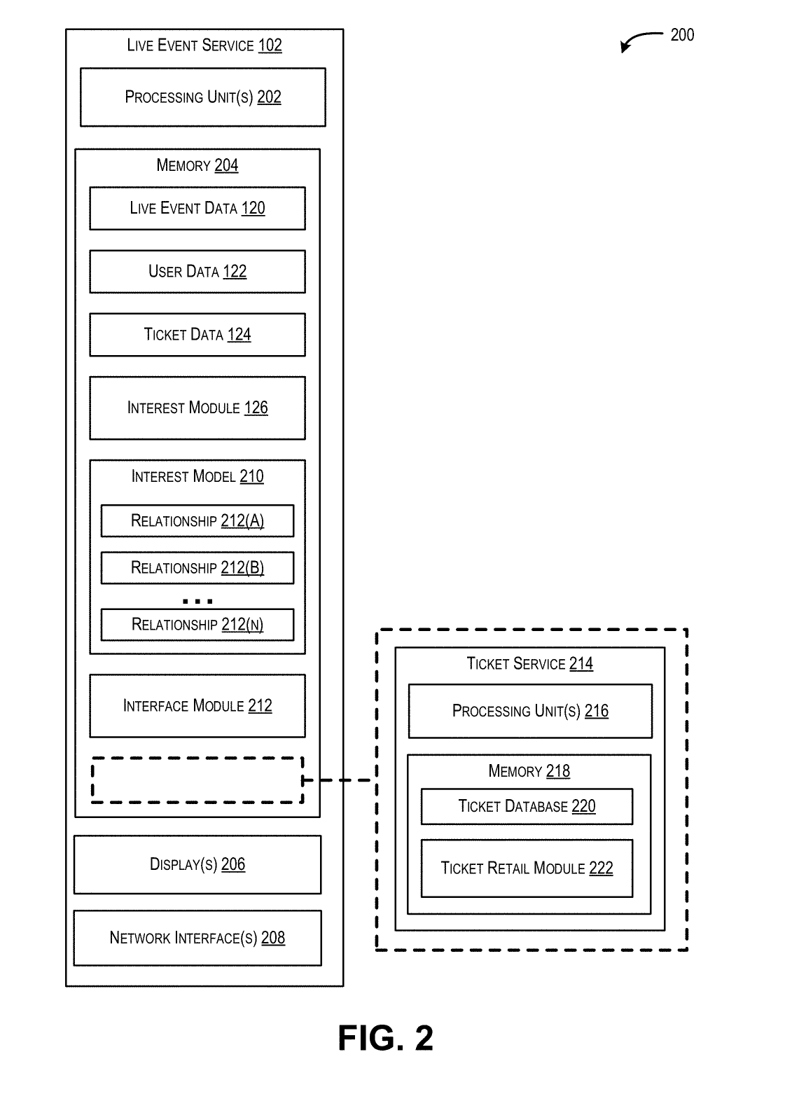

FIG. 2 is a block diagram of an illustrative computing architecture 200 for estimating interest in upcoming live events. The computing architecture 200 associated with the live event service 102 may be used to implement the various systems, devices, and techniques discussed above. In the illustrated implementation, the computing architecture 200 includes one or more processing units 202 coupled to memory 204. The computing architecture 200 may also include one or more displays 206 and one or more network interfaces 208. The network interface 208 may include physical and/or logical interfaces for connecting the live event service 102, to the servers 110, the act computing devices 112, the venue computing devices 114, the user computing devices 116, the third-party live event service(s), the networks 130, etc. For example, the network interface 208 may enable WiFi-based communication such as via frequencies defined by the IEEE 802.11 standards, short range wireless frequencies such as Bluetooth®, or any suitable wired or wireless communications protocol that enables the respective computing device to interface with other computing devices.

The live event service 102 can include the live event data 120, the user data 122, and/or the ticket data 124 stored on the memory 204. The live event data 120 may be data that identifies characteristics associated with the live event 104. For example, characteristics indicated by the live event data 120 may include the date and time of events, types of event, the act(s) 106 involved in the live event 104, the genre/subgenre/classification of the live event 104 and/or an individual act 106, similar events by the act(s) 106 (e.g., multiple shows at the venue, other tour dates, periodic performances, etc.), regional popularity, and/or other modifiers that might affect the level of interest in the live event 104 (e.g., this is the act's final tour, the live event 104 is the last show of a tour, the live event 104 is an album release party, special guests/performers, hometown performance, a promotion being run at the live event 104, etc.), or other information that indicates information about a live event 104. The live event data 120 may identify characteristics of the venue 104, such as size, seating capacity, and past ticket sales for live events 104 at the venue, average attendance, seating types, etc. The live event data 120 may also identify characteristics of the acts 106 participating in the live event 104, such as ticket information for past performances (e.g., sales, prices, ticket sale velocity, locations, types of fans, etc.), album sales, album release dates, critical or social acclaim (e.g., awards, reviews, media coverage, etc.), social media information (e.g., social medial mentions, trending, etc.), etc.

The user data 122 may include data that indicates information/affinities of potential ticket purchasers. For example, characteristics indicated by the user data 122 may include a user's favorite acts, favorite genres, liked albums, types of live events in which they have previously purchased tickets, affinity for attending live events, type of seating preferred, type of venue preferred, pricing thresholds for one or more types of seating, demographic information about the user, geographic information of the user, other users that they go to live events 104 with, etc. An affinity of a user may correspond to a known preference of a user. For example, a user may be known to have a preference for college football, to be a fan of both the University of Washington and the University of Georgia, to have an aversion to purchasing tickets to events that cost more than $40 (i.e., has a history of purchasing tickets in the price range of $0-39, but not $40 or more), to prefer assigned seating at live events over general admission, etc.

The user data 122 may be collected by the live event service 102 or one or more other associated services via interactions with user computing device 116 associated with individual users 118.

The ticket data 124 may correspond to data that indicates information relating to information relating to ticket sales for one or more past live events 104. For example, characteristics indicated by the ticket data 124 may include a number of tickets sold, velocity of ticket sales, price of tickets, types of tickets offered, price of tickets on secondary markets, an amount of time until the live event 104 sold out, users that attended the live event 104, etc. The ticket data 124 may be generated by the live event service 102, or may be received from one or more other sources such as ticket selling services, the venue computing devices 114, the third-party live event service 128, etc.

The live event service 102 can also include interest module 126 and interface module 212 stored on the memory 204. The interest module 126 can be executable by one or more processing units 202 to use one or more types of data (e.g., the live event data 120, the user data 122, the ticket data 124, etc.) to estimate future interest in a live event 104. In some embodiments, the interest module 126 can use the one or more types of data to determine one or more relationships 212 that are indicative of interest in tickets to a live event 104. A relationship 212 may correspond to a combination of characteristics of one or more of users, venues 108, acts 106, and/or live events 104 that correlate with either an increase interest in a live event 104 (i.e., more tickets sold, higher ticket prices, higher ticket velocity, etc.) or a decrease in interest in a live event 104 (i.e., less tickets sold, lower ticket prices, lower ticket velocity, etc.). In some embodiments, the relationships 212 may correspond to one or more weights that are indicative of the strength of a correlation between a combination of one or more characteristics of a live event 104 and interest in the live event 104. For example, where the interest module 126 identifies a strong correlation between users who listen to EDM music and purchasing tickets to live events 104 at the Grand Old Opry House, the interest module 126 may assign a weight to this relationship that is indicative of users having this characteristic having a very small likelihood of purchasing tickets to an event at the Grand Old Opry House.

Alternatively, or in addition, the interest module 126 may generate an interest model 210 that includes and/or uses the one or more relationships 212 to determine an estimated level of interest in an upcoming live event 104. The interest model 210 may be configured to receive one or more characteristics of an upcoming live event 104 (i.e., characteristics of one or more of venues, acts, etc.), and to then use the previously determined relationships 212 to determine an estimated level of interest in the upcoming live event 104. For example, for an upcoming live event 104 where a first act is performing at a venue on a Friday night, and where a first relationship 212(A) indicates that acts similar to the act tend to have a higher than normal level of interest, and a second relationship 212(B) indicates that live events 104 at the venue have a higher than normal interest for live events 104 on Friday, the interest model 210 may predict a very high level of interest in the live event 104.

In some embodiments, the live event service 102 may maintain the interest model 210 by identifying new relationships and/or modifying previously determined relationships based on new data and/or new relationships identified by the interest module 126. For example, the live event service 102 may receive data that corresponds to performance of a live event 104 after it occurs (e.g., a number of tickets sold, a time at which the live event 104 sold out, price of tickets on secondary markets/third-party ticket services, a number of people that attended, how much merchandise was purchased, etc.). The interest module 126 may then compare one or more of the characteristics of the live event 104, a previously predicted level of interest in the live event 104, and the performance of the live event 104. The interest module 126 may then modify, remove, and/or add relationships 212 based on the comparison. In some embodiments, modifying the relationships may include adjusting one or more weights so that they indicate a modified correlation between a combination of one or more characteristics of a live event 104 and interest in the live event 104. The live event service 102 may also use computer learning to optimize such a model to improve its ability to predict interest in upcoming live events 104. In some embodiments, the interest model 210 may also be configured to determine a price for tickets to an upcoming event based at least in part on the determined estimated level of interest in an upcoming live event 104. For example, the interest model 210 may use relationships 212, characteristics of a live event 104, and characteristics of users 118 located within a threshold distance of a venue 108 hosting the live event 104, etc. to determine a first likelihood that users 118 will purchase a ticket to the live event 104 if the tickets have a first price, and a second likelihood that users 118 will purchase a ticket to the live event 104 if the tickets have a second price. The interest model 210 can then use the determine likelihoods to recommend a price for the tickets that is estimated to result in the highest number of tickets sold, the greatest profit, etc.

The interface module 212 can be executable by one or more processing units 202 to generate interfaces that provide one or more services to users, acts, venues, representatives thereof, or a combination thereof. For example, the interface module 210 may generate an interface that contains functionality to input and/or adjust one or more characteristics of an upcoming live event 104, and present an estimated level of interest in the upcoming live event 104 based on the input and/or adjusted one or more characteristics and the interest model 210. In this way, users, acts, venues, representatives, etc. may use the interface to see how changing one or more characteristics of an upcoming live event 104 (e.g., dates, times, different ticket prices, different acts, general admission vs. seated tickets, etc.) would likely impact interest in the live event 104. Alternatively, or in addition, the interface may present one or more other values using the estimated level of interest in an upcoming event, such as an expected velocity of tickets sales at different price points, an estimated probability/date that the live event 104 will sell out, total sales of tickets to the live event 104, what users or groups of users are likely to be interested in purchasing tickets to the live event 104, etc.

In some embodiments, the interface module 212 may generate an interface that contains functionalities that enable venues to manage and/or determine optimal characteristics for an upcoming live event 104. For example, the interface may indicate what price to sell tickets to an upcoming live event 104, what type of tickets to sell (e.g., VIP, general admission, seated admission,), etc. The interface may also contain functionalities that enable venues to select acts/events to book at their location (i.e., what acts/events are estimated to generate highest level of interest). For example, the interface may include functionalities for modifying/adjusting characteristics of an upcoming live event 104 and/or may present an estimated interest in a live event 104 having the modified/adjusted characteristics. The interface may also present one or more recommendations of live events 104 and/or characteristics of live events 104 that would generate an estimated high/increase in interest. For example, the where the interest model 210 indicates that booking a live event 104 on a Tuesday instead of a Wednesday would likely result in a higher level of interest in the live event 104, the interface may recommend that the venue move the data of the live event 104 to a Tuesday.

In some embodiments, the interface module 212 may generate an interface that contains functionality for determining venues 108 at which an act should book live events 104, what cities to include in their live event tours, what other acts to include in individual live events 104, a pricing for tickets, etc. For example, based on the interest model 210, the interface may present estimated levels of interest of live events 104 in one or more cities, venues, dates, etc. The interface may also include functionality for allowing acts and/or their representatives to input their goals (e.g., maximizing its profits, maximizing exposure, etc.), and may present recommendations of live events 104 and/or characteristics of live 104 events based on the goals.

Alternatively, or in addition, the interface may include indications of how many tickets have been sold to upcoming shows, ticket sales velocity for upcoming shows, whether/when upcoming shows are expected to sell out, options for increasing advertising for upcoming shows, etc. In this way, the interface may allow acts and/or their representatives to monitor and update their upcoming live events 104.

FIG. 2 further illustrates a ticket service 214 configured to operate a website, portal, application, widget, etc. that provides functionalities for viewing and obtaining tickets to live events 104. FIG. 2 illustrates the ticket service 214 being separate from the live event service 102, but persons having ordinary skill in the art will understand that the ticket service 214 may in some embodiments be a component of the live event service 102 (e.g., be a module that executes on memory 204 of the live event service 102).

FIG. 2 illustrates that ticket service 214 includes one or more processing units 216 coupled to a memory 218. FIG. 2 further illustrates ticket database 220 and ticket retail modules 222 as being stored on the memory 218. The ticket database 220 may correspond to a database of available tickets and encumbered tickets for an upcoming live event 104. The database may indicate one or more characteristics for the tickets such as, availability, seating type, seating location, price, users who have purchased tickets, estimated value, value on secondary markets, etc.

The ticket retail module 222 can be executable by one or more processing units 216 to generate and/or provide an interface for browsing, searching, and/or obtaining tickets for a live event 104. For example, the interface may include functionalities that allow users to browse available tickets (e.g., via an interactive seat map associated with a venue of the live event 104), and purchase tickets to the live event 104. In some embodiments, the interface may also include functionality for determining whether tickets for a live event 104 are reasonably priced (i.e., whether the price of a ticket is a fair reflection of the value/interest in the ticket), predicting future changes in ticket prices (e.g., sold by the processors or on secondary markets), etc.

In some embodiments, the ticket retail module 212 may use the estimated level of interest in a live event 104 determined by interest model 210 to dynamically price tickets for a live event 104, so that price for obtaining tickets via the interface reflect the estimated interest in the live event 104. In this way, the value of the interest in the live event 104 may be captured by the acts and the venues, and not resellers on a secondary market.

Those skilled in the art will appreciate that the computing architecture 200 is merely illustrative and is not intended to limit the scope of the present disclosure. In particular, the computing system and devices may include any combination of hardware or software that can perform the indicated functions, including computers, network devices, internet appliances, PDAs, wireless phones, pagers, etc. The computing architecture 200 may also be connected to other devices that are not illustrated, or instead may operate as a stand-alone system. In addition, the functionality provided by the illustrated components may in some implementations be combined in fewer components or distributed in additional components. Similarly, in some implementations, the functionality of some of the illustrated components may not be provided and/or other additional functionality may be available.

The one or more processing unit(s) 202 and 216 may be configured to execute instructions, applications, or programs stored in the memory 204 and 218. In some examples, the one or more processing unit(s) 202 and 216 may include hardware processors that include, without limitation, a hardware central processing unit (CPU), a graphics processing unit (GPU), and so on. While in many instances the techniques are described herein as being performed by the one or more processing units 202 and 216, in some instances the techniques may be implemented by one or more hardware logic components, such as a field programmable gate array (FPGA), a complex programmable logic device (CPLD), an application specific integrated circuit (ASIC), a system-on-chip (SoC), or a combination thereof.

The memory 204 and 218 are an example of computer-readable media. Computer-readable media may include two types of computer-readable media, namely computer storage media and communication media. Computer storage media may include volatile and non-volatile, removable, and non-removable media implemented in any method or technology for storage of information, such as computer readable instructions, data structures, program modules, or other data. Computer storage media includes, but is not limited to, random access memory (RAM), read-only memory (ROM), erasable programmable read-only memory (EEPROM), flash memory or other memory technology, compact disc read-only memory (CD-ROM), digital versatile disk (DVD), or other optical storage, magnetic cassettes, magnetic tape, magnetic disk storage or other magnetic storage devices, or any other non-transmission medium that may be used to store the desired information and which may be accessed by a computing device. In general, computer storage media may include computer-executable instructions that, when executed by one or more processing units, cause various functions and/or operations described herein to be performed. In contrast, communication media embodies computer-readable instructions, data structures, program modules, or other data in a modulated data signal, such as a carrier wave, or other transmission mechanism. As defined herein, computer storage media does not include communication media.

Those skilled in the art will also appreciate that, while various items are illustrated as being stored in memory or storage while being used, these items or portions of them may be transferred between memory and other storage devices for purposes of memory management and data integrity. Alternatively, in other implementations, some or all of the software components may execute in memory on another device and communicate with the illustrated computing architecture 200. Some or all of the system components or data structures may also be stored (e.g., as instructions or structured data) on a non-transitory, computer-accessible medium or a portable article to be read by an appropriate drive, various examples of which are described above. In some implementations, instructions stored on a computer-accessible medium separate from the computing architecture 200 may be transmitted to the computing architecture 200 via transmission media or signals such as electrical, electromagnetic, or digital signals, conveyed via a communication medium such as a wireless link. Various implementations may further include receiving, sending or storing instructions and/or data implemented in accordance with the foregoing description upon a computer-accessible medium.

The architectures, systems, and individual elements described herein may include many other logical, programmatic, and physical components, of which those shown in the accompanying figures are merely examples that are related to the discussion herein.

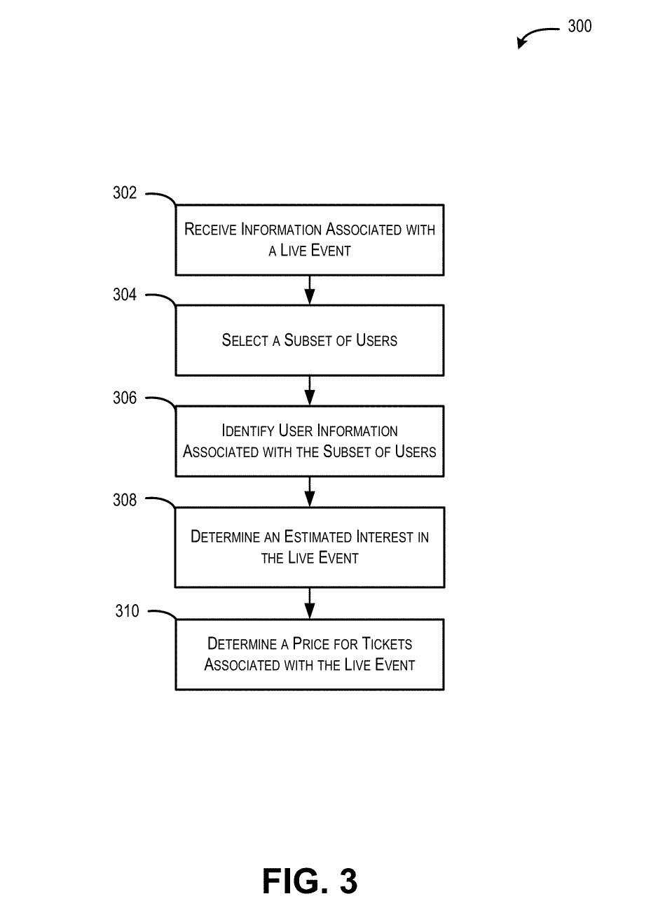

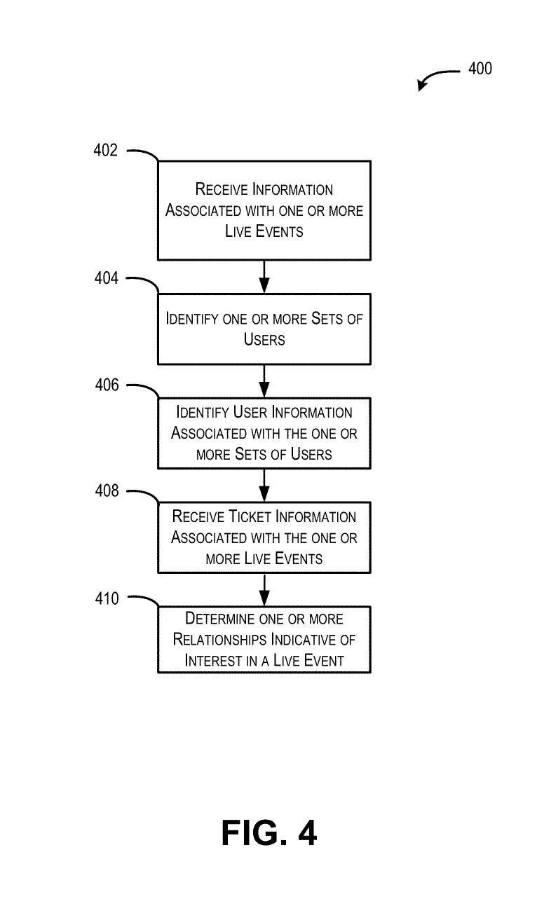

FIGS. 3 and 4 are flow diagrams of illustrative processes illustrated as a collection of blocks in a logical flow graph, which represent a sequence of operations that can be implemented in hardware, software, or a combination thereof. In the context of software, the blocks represent computer-executable instructions stored on one or more computer-readable storage media that, when executed by one or more processors, perform the recited operations. Generally, computer-executable instructions include routines, programs, objects, components, data structures, and the like that perform particular functions or implement particular abstract data types. The order in which the operations are described is not intended to be construed as a limitation, and any number of the described blocks can be combined in any order and/or in parallel to implement the processes.

FIG. 3 is a flow diagram of an illustrative process 300 to determine ticket prices for an upcoming live event 104 based on estimated interest in the upcoming live event 104. The process 300 may be implemented in the environment 100 and by the computing architecture 200 described above, or in other environments and architectures.

At 302, the live event service 102 receives information associated with a live event 104. In some embodiments, the ticket information may correspond to live event data that identifies characteristics associated with an upcoming live event 104, such as information about the venue hosting the upcoming live event 104, the one or more acts performing during the upcoming live event 104, one or characteristics of the live event 104, or a combination thereof. For example, the live event data may identify characteristics of (i) the venue hosting the upcoming live event 104, such as size, seating capacity, and past ticket sales for live events 104 at the venue, average attendance, seating types, etc., (ii) the acts participating in the upcoming live event 104, such as ticket information for past performances, genre, subgenre, similar acts, album sales, album release dates, critical or social acclaim, social media information, etc., and (iii) the upcoming live event 104 itself, such as the time and date of the upcoming live event 104.

In some embodiments, the live event service 102 may receive the information associated with the live event 104 from one or more computing devices associated with the acts 106 performing at the upcoming live event 104, the venue 108 hosting the live event 104, services responsible for distributing tickets to the upcoming live event 104, representatives thereof, or other individuals associated with the upcoming live event 104. The information may be received via one or more of a website, application programing interface (API), network portal, electronic application, widget, message, SMS, etc.

At 304, the live event service 102 selects a subset of users. In some embodiments, selecting a subset of users may include determining one or more users that live, work, or are otherwise associated with a geographic region associated with the venue 108 that is hosting the upcoming live event 104. For example, the live event service 102 may identify a group of users that live within a threshold distance (e.g., number of miles, within the same county, one hour drive, etc.) of a venue 108 that is scheduled to host an upcoming live event 104.

Alternatively, or in addition, selecting the subset of users may include identifying users 118 that have certain characteristics, such as a combination of one or more traits, affinities, demographics, past purchases, membership status, etc. For example, the live event service 102 may identify a set of users that previously obtained a ticket to a live event 104 generally, to a live event 104 associated with the venue 108 hosting the upcoming live event 104, to a live event 104 associated with one or more acts 106 performing at the upcoming live event 104, to a live event 104 associated with venues 108 or acts 106 similar to the venue 108 and acts 106 associated with the upcoming live event 104, that are members of a live event ticket program/group, that are members of another group associated with the live event service 102, etc. The live event service 102 may also identify users that are fans (i.e., have liked, followed, browsed, purchased related merchandise, or otherwise shown an affinity for) of an act 106 performing at the upcoming event (or similar acts 106). In some embodiments, the subset of users may be all users known by the live event service 102.

At 306, the live event service 102 identifies user information associated with the subset of users. In some embodiments, the user information may correspond to user data may include data that indicates information/affinities of individual users 118 in the subset of users. For example, characteristics indicated by the user data may include a user's favorite acts, favorite genres, liked albums, a purchase history of the user (e.g., merchandise, services, items, live events they have previously purchased tickets to, etc.), affinity for going to live events 104, type of seating preferred, type of venue 108 preferred, pricing thresholds for one or more types of seating, demographic information about the user, geographic information of the user, other users that they go to live events 104 with, etc. User data may be collected by the live event service 102 or one or more other associated services via interactions with user computing device associated with individual users.

At 308, the live event service 102 determines an estimated interest in the live event 104. The estimated interest in the live event 104 may correspond to a likelihood that users 118 will purchase tickets to the live event 104. The estimated interest may be a collection of values, with individual values corresponding to a likelihood that a corresponding user will purchase tickets, may be a cumulative likelihood of the group of users to buy tickets, or a combination thereof. Alternatively, or in addition, the estimated interest may correspond to a designation such as “low,” “medium,” “high,” etc. that is determine using the weights and/or likelihoods. In some embodiments, the live event service 102 may determine the estimated interest based on the information associated with the live event 104, the user information, and one or more relationships indicative of interest in a live event 104. Such relationships may correspond to a combination of characteristics of one or more of users, venues 108, acts 106, and/or live events 104 that correlate with either an increase interest in a live event 104 (i.e., more tickets sold, higher ticket prices, higher ticket velocity, etc.) or a decrease in interest in a live event 104 (i.e., less tickets sold, lower ticket prices, lower ticket velocity, etc.). For example, based on the information associated with the live event 104 indicating that two of the acts 106 performing at an upcoming event are the Dallas Cowboys and the Philadelphia Eagles, and the relationships indicate that live events 104 involving both of these two acts 106 tend to display a greatly increased level of popularity, the live event service 102 may estimate a high level of interest in the upcoming live event 104.

Alternatively, or in addition, the live event service 102 may determine the estimated interest based on the information associated with the live event 104, the user information, and an interest model 210 that includes and/or uses the relationships to determine an estimated level of interest in an upcoming live event 104. The interest model 210 may be configured to receive one or more characteristics of an upcoming live event 104 (i.e., characteristics of one or more of venues, acts, etc.), and to then use the relationships to determine an estimated level of interest in the upcoming live event 104. In some embodiments, the live event service 102 may determine the estimated interest based on one or more weights that are indicative of the strength of a correlation between a combination of one or more characteristics of a live event and interest in the live event 104.

At 310, the live event service 102 determines a price for tickets associated with the live event 104. In some embodiments, the live event service 102 may determine the price for tickets to an upcoming event based at least in part on the determined estimated level of interest in an upcoming live event 104. For example, the interest model 210 may use relationships 212, characteristics of a live event 104, and characteristics of users 118 located within a threshold distance of a venue 108 hosting the live event 104, to determine a first likelihood that users 118 will purchase a ticket to the live event 104 if the tickets have a first price, and a second likelihood that users 118 will purchase a ticket to the live event 104 if the tickets have a second price. The interest model 210 can then use the determine likelihoods to recommend a price for the tickets that is estimated to result in the highest number of tickets sold, the greatest profit, etc.

The live event service 102 may also use estimated level of interest in an upcoming event to estimate other values such as an expected velocity of tickets sales at different price points, an estimated probability/date that the live event 104 will sell out, total sales of tickets to the live event 104, what users or groups of users are likely to be interested in purchasing tickets to the live event 104, etc.

FIG. 4 is a flow diagram of an illustrative process 400 to determine one or more relationships indicative of interest in a live event. The process 400 may be implemented in the environment 100 and by the computing architecture 200 described above, or in other environments and architectures.

At 402, the live event service 102 receives information associated with one or more live events 104. In some embodiments, the information may correspond to live event data 120 that identifies characteristics associated with the one or more live events 104, such as information about the venues 108 that hosted the one or more live events 104, the one or more acts 106 that performed during the one or more live events 104, one or characteristics of the one or more live events 104, or a combination thereof. For example, the live event data 120 may identify characteristics of (i) individual venues 108 that hosted the one or more live events 104, such as size, seating capacity, and past ticket sales for live events 104 at the venue, average attendance, seating types, etc., (ii) the acts 106 that performed in individual events of the one or more live events 104, such as ticket information for past performances, genre, subgenre, similar acts, album sales, album release dates, critical or social acclaim, social media information, etc., and (iii) individual live events 104 of the one or more live events 104 themselves, such as a time and date of individual live events 104.

In some embodiments, the live event service 102 may receive the information associated with the one or more live events 104 from one or more computing devices associated with the acts 106 that performed at the one or more live events 104, the venues 108 that hosted the one or more live events 104, services responsible for distributing tickets to the one or more live events 104, representatives thereof, or other individuals associated with the one or more live events 104. The information may be received via one or more of a website, application programing interface (API), network portal, electronic application, widget, message, SMS, etc. Alternatively, or in addition, the information may be input directly into the live event service 102 and/or obtained from third party resources such as ticket distribution websites.

At 404, the live event service 102 selects one or more sets of users. In some embodiments, selecting the sets of users may include determining one or more users 118 that obtained tickets to, attended, or are otherwise associated with an individual live event 104 of the one or more live events 104. For example, for individual live events 104 of the one or more live events 104 the live event service 102 may identify a group of users 118 that obtained tickets to, attended, or are otherwise associated with an individual live event of the one or more live events 104.

At 406, the live event service 102 identifies user information associated with the one or more sets of users. In some embodiments, the user information may correspond to user data that indicates information/affinities of individual users in the one or more sets of users. For example, characteristics indicated by the user data may include a user's favorite acts, favorite genres, liked albums, types of live events 104 they have previously purchased tickets to, affinity for going to live events 104, type of seating preferred, type of venue preferred, pricing thresholds for one or more types of seating, demographic information about the user, geographic information of the user, other users that they go to live events 104 with, etc. User data may be collected by the live event service 102 or one or more other associated services via interactions with user computing device associated with individual users.

At 408, the live event service 102 receives ticket information associated with the one or more live events 104. In some embodiments, the ticket information may correspond to ticket data that indicates information relating to information relating to ticket sales for individual events of the one or more live events 104. For example, characteristics indicated by the ticket data may include a number of tickets sold, velocity of ticket sales, price of tickets, types of tickets offered, price of tickets on secondary markets, time until the live event sold out, users that attended the live event 104, etc. Ticket data may be generated by the live event service 102, or may be received from one or more other sources such as ticket selling services, venue computing device, third-party live event service, etc.

At 410, the live event service 102 determines one or more relationships indicative of interest in a live event 104. In some embodiments, the live event service 102 may use the information associated with the one or more live events 104, the user information associated with the one or more sets of users, and the ticket information to determine one or more relationships that are indicative of interest in tickets to a live event 104. A relationship may correspond to a combination of characteristics of one or more of users, venues, acts, and/or live events 104 that correlate with either an increase interest in a live event 104 (i.e., more tickets sold, higher ticket prices, higher ticket velocity, etc.) or a decrease in interest in a live event 104 (i.e., less tickets sold, lower ticket prices, lower ticket velocity, etc.). In some embodiments, the live event service 102 may also be configured to determine one or more weights associated with individual relationships that are indicative of the strength of a corresponding correlation between a combination of one or more characteristics of a live event 104 and interest in the live event 104.

Alternatively, or in addition, the live event service 102 may generate an interest model 210 that includes and/or uses the one or more relationships, and that is configured to determine an estimated level of interest in an upcoming live event 104. The interest model may be configured to receive one or more characteristics of an upcoming live event 104 (i.e., characteristics of one or more of venues, acts, etc.), and to then use the determined relationships to determine an estimated level of interest in the upcoming live event 104.

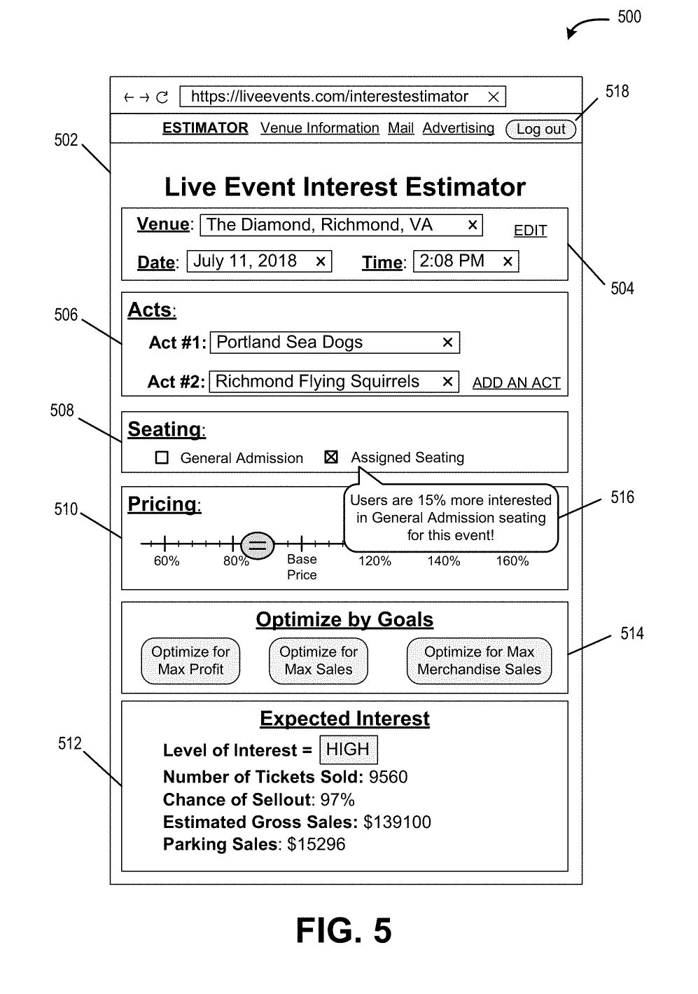

FIG. 5 is an example illustration 500 of a live event interest estimation service. In some embodiments, the illustration 500 may include an interface 502. The interface 502 may be a graphical user interface that is presented as part of a website, portal, application, widget, etc. associated with the live event service 102.

FIG. 5 shows interface 502 as including multiple elements for presenting and editing characteristics associated with a live event 104. For example, interface element 504 presents the time, date, and venue of the live event 104, and presents functionality for editing these characteristics. FIG. 5 also shows elements 506 and 508 as presenting characteristics relating to the acts and the type of seating for the live event 104, respectively. The interface 502 is further shown as including an element for selecting the prices of tickets for the live event 104. Element 510 is shown as including a slider that allows a user to adjust the pricing of tickets for the live event 104 in relation to the base prices for the venue. The interface 512 may also include an element 512 that presents the estimated level of interest in a live event 104 having the characteristics presented in elements 504-510. In some embodiments, element 512 may also display other estimated information such as a number of tickets expected to be sold, a chance of selling out all tickets to the live event 104, a date that all tickets for the live event 104 are expected to be sold, an estimated gross ticket sales for the live event 104, etc. In response to one or more characteristics presented in 504-510 being changed, element 512 may be configured to update the information it displays so that it reflects a new expected interest in a live event 104 having the updated characteristics.

FIG. 5 also illustrates an element 514 for optimizing live event characteristics to meet one or more goals. For example, the element 514 may include options to optimize characteristics of an upcoming live event 104 so as to maximize profits, maximize ticket sales, maximize merchandise sales (e.g., parking, albums, food, drinks, clothing, etc.), to maximize social media interest (e.g., to generate the most interest from users that have a large social media presence), or a combination thereof. In this way, the interface 502 uses estimated levels of interest to select characteristics of the live event 104 that are likely to cause an upcoming live event 104 to meet the goals of the venue 108/act 106/other party.

In some embodiments, the interface 502 may present recommendations 516 of characteristics and/or changes of characteristics that result in an increase in expected interest. For example, based on the live event service 102 determining that users are more likely to be interested in purchasing general admission tickets to an AA minor league baseball game, as opposed to tickets having assigned seating, the interface 502 may present a recommendation 516 that the type of seating for the live event 104 be changed to general admission. FIG. 5 further illustrates interface 502 having a menu 518 for navigating one or more services offered by the live event service 102, such as mail, advertising, etc.

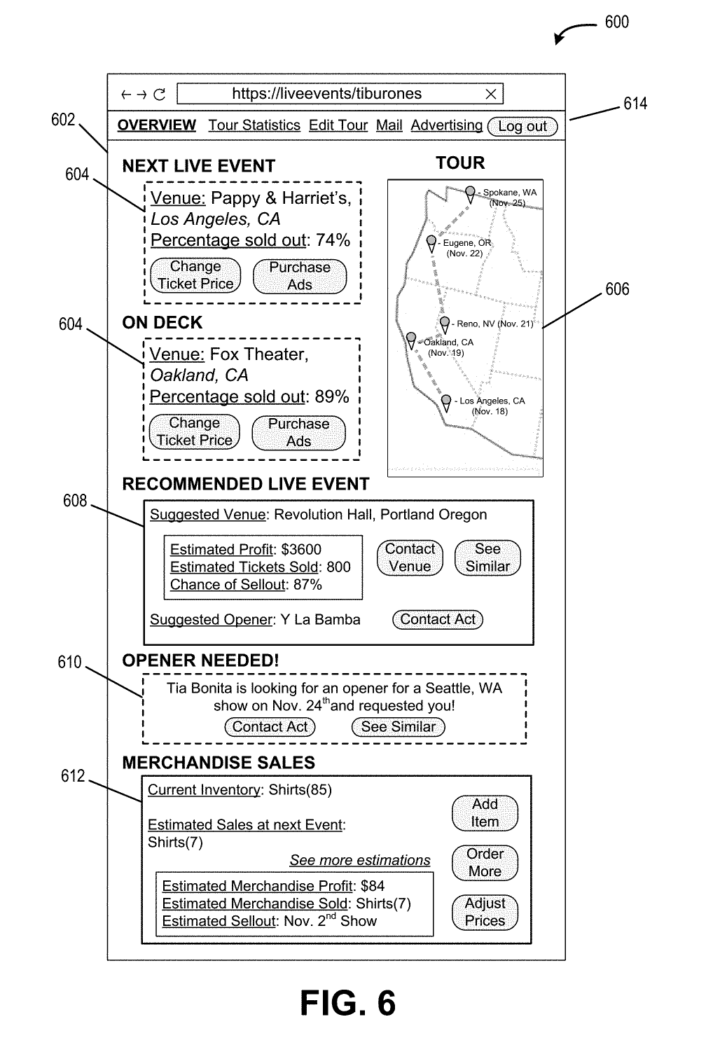

FIG. 6 is an example illustration 600 of a service for managing and scheduling live events using a live event interest service. In some embodiments, the illustration 600 may include an interface 602 that enables an act or their representative to manage and schedule live events 104. The interface 602 may be a graphical user interface that is presented as part of a website, portal, application, widget, etc. associated with the live event service 102.

FIG. 6 shows the interface 602 as including one or more elements 604 that present information relating to upcoming live events 104, such as the venue, ticket sales information, etc. Elements 604 may also include functionalities for editing one or more characteristics of an associated live event 104, such as changing a time, ticket price, etc. The element(s) 604 may also include functionality for purchasing and/or adjusting advertising for an upcoming live event 104. The interface 602 may also include a visual representative 606 of live events 104 associated with an act.

FIG. 6 also shows a recommendation 608 of a live event 104. The recommendation 606 may include recommended characteristics for the recommended live event 104 such as acts, venues, dates, ticket prices, etc. The recommendation 608 may also include estimated information about the recommended live event 104, such as an estimate profit, number of tickets sold, chance of the recommended live event 104 selling out, etc. In some embodiments, the recommended live event 104 and/or one or more characteristics of the recommended live event 104 may be determined by the live event service 102 using and interest model and/or relationships indicative of interest in live events 104. The recommendation 608 may also be generated based on other information, such as a schedule of an act. For example, where an act currently has a first live event 104 in Eugene, Oreg. on November 22^{nd}, and a second live event 104 in Spokane, Wash. on November 25^{th}, the interface may recommend that the act add a show in Portland, Oreg. on one of November 23^{rd} or 24^{th} (since one would likely travel through Portland, Oreg. from Eugene, Oreg. to Spokane, Wash.). The recommendation 608 may also include a recommendation of one or more acts that live event service 102 estimates would increase interest in the live event 104.

FIG. 6 further illustrates the interface 602 as including a notification 610 that an act is needed for an upcoming live event 104. The notification 610 may include a functionality for scheduling the live event 104, and/or contacting a representative associated with the live event 104. The interface 602 may also include one or more elements 612 that use estimated interest to manage merchandise sales. For example, the interface may present and element 612 that identifies merchandise information, such as a merchandise inventory, estimated future sales, optimal prices for merchandise at future events (e.g., expected ticket purchasers of some live events 104 may be willing to pay a higher price for merchandise), an estimated sell out date where current inventory will run out, etc. In some embodiments, the element 612 may include options to add new merchandise items, or order more merchandise items for a merchandise provider. In this way, an act 106 may use the interface 106 to ensure that they charge optimal prices for merchandise to meet their goals (e.g., most sales, highest profit, etc.), and that they will have enough merchandise to meet future demand. FIG. 6 further illustrates the interface 602 having a menu 614 for navigating one or more services offered by the live event service 102, such as mail, advertising, etc.

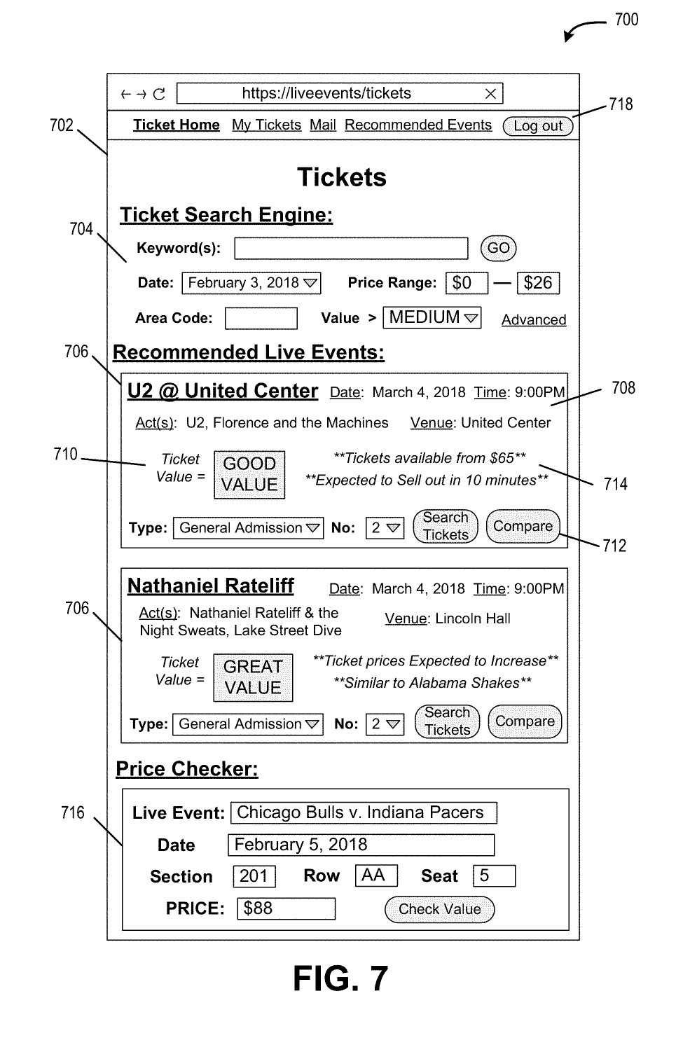

FIG. 7 is an example illustration 700 of a service for browsing and obtaining tickets to live events using a live event interest service. In some embodiments, the illustration 700 may include an interface 702 that users to browse and obtain tickets to live events 104. The interface 702 may be a graphical user interface that is presented as part of a website, portal, application, widget, etc. associated with the live event service 102.

FIG. 7 shows the interface 702 as including a search element 704 that provides functionality for searching for tickets to a live event 104. A user may enter characteristics of a desired live event 104 into the search element 704 and submit a request that the live event service 702 present ticket information for events having the entered characteristics. In some embodiments, the search element 704 may also allow the user to input one or more other characteristics of a live event 104 (e.g., date, price range, location, venue 108, value, etc.), and the interface 704 may identify live events 104 that have the user's desired characteristics. The interface 702 may also include one or more recommendations 706 of live events 104. The live events 104 included in the recommendation(s) 706 may be determined based on information associated with a user viewing the interface (e.g., a live event 104 that the user is predicted to be interested in), information associated with the live event 104 (e.g., the live event 104 is nearby/soon), estimated interest in the live event 104 (e.g., the live event service 102 estimates a high level of interest in the show, that the show is about to sell out, etc.), the live event 104 being a good deal (e.g., the price of tickets to the live event 104 being lower than expected for a live event 104 with an associated level of expected interest), or a combination thereof. In some embodiments, the recommendation(s) 706 may present characteristics 708 of the live event 104, an estimated value 710 of the tickets (i.e., the relationship between the price of tickets to the live event 104 and an expected level of interest in the live event 104 as determined by the live event service 102), and/or functionality 714 for selecting and obtaining tickets to the recommended live event 104. In some embodiments, the recommendation(s) 706 may also include one or more additional notifications 714, such as ticket pricing, expected time that the live event 104 will sell out, that prices are expected to increase, that an act is similar to another act that a user is known to like, etc.

FIG. 7 also shows a price checking element 716. The price checking element 716 may be configured to receive an identifier of a live event 104 and/or on or more characteristics of a live event 104 (e.g., date, acts, venue, etc.), and information associated with a ticket (e.g., seating type, price, etc.), and determine whether the ticket represents a good value. For example, the price checking element 716 may display that a ticket is a good value if the price of the ticket is low in relation to an expected interest in the live event 104 as determined by the live event service 102. FIG. 7 further illustrates the interface 702 as having a menu 718 for navigating one or more services offered by the live event service 102, such as mail, recommended live events 104, etc.

Although the subject matter has been described in language specific to structural features and/or methodological acts, it is to be understood that the subject matter defined in the appended claims is not necessarily limited to the specific features or acts described. Rather, the specific features and acts are disclosed as exemplary forms of implementing the claims.

What is claimed is:

1. A system comprising:
one or more processors; and
memory coupled to the one or more processors, the memory storing instructions that, when executed by the one or more processors, cause the one or more processors to:
receive first live event data, the first live event data indicating that a first venue and an act are associated with a live event;
identify, based on the first live event data, a set of first users that obtained tickets to the live event;
identify first user data associated with the set of first users, the first user data indicating first affinities and demographic traits associated with the set of first users;
receive ticket data that indicates ticket sales information associated with the live event;
determine, based on the first live event data, the first user data, and the ticket data, a relationship between at least one affinity or demographic trait and an increased likelihood of purchasing a ticket to the live event;
receive second live event data, the second live event data indicating that a second venue and the act are associated with an upcoming live event that has yet to occur;
identify a set of second users that are located within a threshold distance of a location of the second venue;
identify second user data associated with the set of second users, the second user data indicating second affinities and demographic traits associated with the set of second users; and
determine, based on the second live event data, the second user data, and the relationship, an estimated interest in the upcoming live event.

2. The system as in claim 1, wherein the instructions cause the one or more processors to:
determine, based on the second live event data, the second user data, and the relationship, a first estimated interest in purchasing first tickets to the upcoming live event, the first tickets having a first price;
determine, based on the second live event data, the second user data, and the relationship, a second estimated interest in purchasing second tickets to the upcoming live event, the second tickets having a second price; and
determining, based on the first estimated interest and the second estimated interest, a value for tickets to the upcoming live event.

3. The system as in claim 1, wherein determining the estimated interest in the upcoming live event comprises:
determining a first estimated interest in a first type of ticket for the upcoming live event; and
determining a second estimated interest in a second type of ticket for the upcoming live event.

4. The system as in claim 1, wherein the estimated interest is a first estimated interest and the instructions cause the one or more processors to:
determine a new characteristic associated with the upcoming live event; and
determine, based on the relationship, a second estimated interest in the upcoming live event having the new characteristic.

5. The system as in claim 4, wherein the instructions cause the one or more processors to provide, based on the second estimated interest being greater than the first estimated interest, a recommendation that the upcoming live event have the new characteristic.

6. A method comprising:
receiving live event data that indicates one or more first characteristics associated with an upcoming live event that has yet to occur;
identifying a set of users associated with the upcoming live event;
identifying user data that indicates one or more second characteristics associated with the set of users;
identifying a relationship between (i) interest in the upcoming live event and (ii) a characteristic of at least one of the one or more first characteristics or the one or more second characteristics; and
determining, based at least in part on the relationship, an estimated interest in the upcoming live event.

7. The method of claim 6, wherein the live event data is first live event data, the user data is first user data, and further comprising:
receiving second live event data, the second live event data indicating one or more third characteristics associated with one or more live events;
identifying, based on the second live event data, an additional set of users associated with the one or more live events;
identifying second user data that indicates one or more third characteristics associated with the additional set of users;
receiving ticket data that indicates ticket sales information associated with the one or more live events; and
determining, based on the second live event data, the second user data, and the ticket data, the relationship.

8. The method of claim 6, further comprising:
receiving new ticket data that indicates new ticket sales information associated with the upcoming live event; and
determining, based at least in part on the new ticket data, a new relationship between (i) interest in the upcoming live event and (ii) the characteristic.

9. The method of claim 6, further comprising:
determining a first potential venue for the upcoming live event and a second potential venue for the upcoming live event,
wherein determining the estimated interest in the upcoming live event comprises:
determining a first estimated interest in the upcoming live event at the first potential venue; and
determining a second estimated interest in the upcoming live event at the second potential venue.

10. The method of claim 6, wherein determining the estimated interest in the upcoming live event comprises:
determining a first estimated interest in a first type of ticket for the upcoming live event; and
determining a second estimated interest in a second type of ticket for the upcoming live event.

11. The method of claim 6, further comprising:
receiving a request for a price of one or more tickets for the upcoming live event; and
determining, based on the estimated interest in the upcoming live event, one or more estimated prices for tickets to the upcoming live event.

12. The method of claim 11, further comprising periodically redetermining the one or more estimated prices for the tickets to the upcoming live event.

13. The method of claim 6, further comprising determining an amount of tickets that are estimated be sold for the upcoming live event based at least in part on the estimated interest in the upcoming live event.

14. The method of claim 6, wherein determining the estimated interest in the upcoming live event comprises:
determining a first potential price for tickets to the upcoming live event and a second potential price for the tickets to the upcoming live event;
determining a first estimated interest in the upcoming live event based at least in part on the first price for the tickets; and
determining a second estimated interest in the upcoming live event based at least in part on the second price for the tickets.

15. A system comprising:
one or more processors; and
memory coupled to the one or more processors, the memory storing instructions that, when executed by the one or more processors, cause the one or more processors to:
receive live event data that indicates one or more first characteristics associated with an upcoming live event;
identify a set of users associated with the upcoming live event;
identify user data that indicates one or more second characteristics associated with the set of users;
identify a relationship between (i) interest in the upcoming live event and (ii) a characteristic of at least one of the one or more first characteristics or the one or more second characteristics; and
determine, based at least in part on the relationship, an estimated interest in the upcoming live event.

16. The system as in claim 15, wherein the live event data is first live event data, the user data is first user data, and the instructions cause the one or more processors to:
receive second live event data, the second live event data indicating one or more third characteristics associated with one or more live events;
identify, based on the second live event data, an additional set of users associated with the one or more live events;
identify second user data that indicates one or more third characteristics associated with the additional set of users;
receive ticket data that indicates ticket sales information associated with the one or more live events; and
determine, based on the second live event data, the second user data, and the ticket data, the relationship.

17. The system as in claim 15, wherein the estimated interest is a first estimated interest and the instructions cause the one or more processors to:
determine a new characteristic associated with the upcoming live event; and
determine, based at least in part on the second live event data, the second user data, and the relationship, a second estimated interest in the upcoming live event having the new characteristic.

18. The system as in claim 17, wherein the instructions cause the one or more processors to provide, based on the second estimated interest being greater than the first estimated interest, a recommendation that the upcoming live event have the new characteristic.

19. The system as in claim 15, wherein the instructions cause the one or more processors to:
receive a price for a ticket associated with the upcoming live event; and
determine, based at least in part on the price and the estimated interest in the upcoming live event, a value of the price.

20. The system as in claim 15, wherein the instructions cause the one or more processors to determine, based at least in part on the estimated interest, a price for a ticket associated with the upcoming live event.
